(19) United States
(12) Patent Application Publication
(10) Pub. No.: US 2026/0264465 A1
(43) Pub. Date: Sep. 10, 2026

(54) TRAILER FOR COUPLING TO AN EXCAVATOR EQUIPPED WITH A HYDRAULIC QUICK COUPLER

(71) Applicant: OilQuick Deutschland KG, Steindorf (DE)

(72) Inventor: Franz SCHAUER, Steindorf (DE)

(73) Assignee: OilQuick Deutschland KG, Steindorf (DE)

(21) Appl. No.: 19/555,121

(22) Filed: Mar. 3, 2026

(30) Foreign Application Priority Data
Mar. 4, 2025 (DE) 10 2025 108 087.9

(51) Int. Cl. B60D 1/64; E02F 3/36; B60P 1/16

(52) U.S. Cl. CPC B60D 1/64; E02F 3/3654; B60P 1/162

(57) ABSTRACT

A trailer for coupling to an excavator equipped with a hydraulic quick coupler. The trailer includes a chassis with wheels and at least one trailer part arranged on the chassis so as to be adjustable by means of an adjusting element. An adapter designed for coupling to the quick coupler is arranged on the trailer with at least one second coupling element designed to engage with a first coupling element on the quick coupler when the quick coupler is coupled to the adapter for supplying and controlling the adjusting element from the excavator.

### FIELD OF THE INVENTION

The invention relates to a trailer for coupling to an excavator equipped with a hydraulic quick coupler. The invention further relates to a construction equipment arrangement comprising an excavator and a trailer of this type.

### BACKGROUND

Modern excavators are often equipped with hydraulic quick couplers for quick and easy changing of attachments. With a quick coupler of this type, swivel buckets, grabs, shears, compactors, magnets, hydraulic hammers or other attachments can be coupled or uncoupled from an excavator boom, for example, from a driver’s cab in just a few seconds while maintaining a high safety standard. DE 10 2018 115 949 A1 describes a quick coupler of this type. It contains a carrier which can be attached to a boom of an excavator and which has on one side first receptacles with a locking device movable between a release position and a locking position for holding a first coupling element provided on an attachment and on the other side second receptacles for holding a second coupling element spaced apart from the first coupling element. The locking device comprises locking elements designed as locking pins, which can be moved by a hydraulically displaceable actuating element, also known as an H-cylinder, between a retracted release position for releasing or coupling an attachment and an extended locking position for holding the attachment. In order to also ensure the supply of hydraulic or electrical power to the attachments and their control with such quick couplers, hydraulic and possibly also electrical coupling elements are also provided on the hydraulically displaceable actuating element of the excavator-side quick coupler for coupling with corresponding counter elements on the attachment. The coupling elements arranged on the quick coupler interact with the mating elements on the attachment side in such a way that when the locking elements are moved into their locking position, a coupling also takes place simultaneously between the coupling elements arranged on the quick coupler and the mating elements arranged on the attachments. This means that the attachments connected to the quick coupler can be supplied with hydraulic and, if necessary, pneumatic and/or electrical power and controlled from the excavator.

When such excavators are used on construction sites, trailers are usually also required to transport the excavated material or attachments. These trailers are usually moved by separate tractor units. However, to move the trailers at least on the construction site, they can also be coupled to an excavator and maneuvered thereby. However, since such trailers often also have hydraulically, pneumatically and/or electrically actuated parts, such as hydraulically or pneumatically tiltable loading surfaces, hydraulically actuated side walls or electrical control or display elements, separate power supply couplings and complex control systems must be provided on the excavator.

### SUMMARY OF THE INVENTION

An aspect of the invention relates to a trailer and a construction equipment arrangement with an excavator and such a trailer, which enable automatic actuation and control of hydraulic, pneumatic and/or electrical actuating elements of the trailer from the excavator, even without any additional control effort.

Advantageous embodiments of the trailer and the construction equipment arrangement of the invention are disclosed herein.

The trailer according to the invention is designed for coupling to an excavator equipped with a hydraulic quick coupler. It comprises a chassis with wheels and at least one trailer part arranged on the chassis so as to be adjustable by means of an adjusting element. An adapter designed for coupling to the quick coupler is arranged on the trailer with at least one second coupling element designed to engage with a first coupling element on the quick coupler when the quick coupler is coupled to the adapter in order to supply and control the actuating element from the excavator. When coupling the excavator-side quick coupler to the trailer-side adapter, the corresponding coupling elements on the trailer-side adapter and the excavator-side quick coupler can be used to establish a hydraulic, pneumatic or even electrical connection between the excavator and the trailer, for example, to control or actuate a hydraulically or electrically operated trailer part. A quick-change device normally used for the automatic changing of attachments can thus also be used to operate actuating elements on the trailer without the need for time-consuming set-up and conversion work on an excavator. No separate couplings or connection devices with the required control need to be provided on the excavator.

In one possible embodiment, the adjustable trailer part can be a tiltable loading trough or loading surface arranged on the chassis and the adjusting element can be an adjusting cylinder arranged between the chassis and the loading trough or loading surface. However, the trailer can also have folding side walls or other adjustable parts, for example, which can be operated from the excavator using corresponding control elements.

The at least one coupling element arranged on the adapter can conveniently be connected to the actuating element via a supply line. A hydraulic supply line can be a hose connection or a fixed pipe connection. Depending on the intended use, the at least one second coupling element arranged on the adapter can be designed as a hydraulic or electrical quick coupling plug.

To actuate and control several trailer parts, several second coupling elements designed to engage with first coupling elements on the quick coupler can also be arranged on the adapter. These can be hydraulic, pneumatic or electric coupling elements.

For the mechanical connection between the quick coupler and the adapter, the adapter expediently contains a first bolt- or axle-shaped coupling element designed to engage with first mounts of the quick coupler and a second bolt- or axle-shaped coupling element designed to engage with second mounts of the quick coupler.

In a further practical embodiment, the at least one second coupling element arranged on the adapter can be held on the second coupling element of the adapter via a coupling element carrier.

In order to avoid collisions between the excavator-side quick coupler and the trailer-side adapter when coupling, the adapter is preferably arranged on a trailer drawbar of the trailer. The adapter can be attached to the trailer drawbar directly or via a damping element, for example. However, the adapter can also be located at another suitable position on the trailer. For example, the adapter can also be located on the chassis. It can also be attached to the body of the trailer, e.g. to a bracket, and optionally secured with a manually or hydraulically operated pin or the like. This means that the adapter would not be fixed to the trailer during operation, allowing for significantly greater maneuverability of the excavator.

The invention also relates to a construction equipment arrangement comprising an excavator equipped with a hydraulic quick coupler and a trailer coupled to the excavator, which is designed as described above.

The quick coupler can be attached to an excavator arm via a rotating and swiveling unit. However, it can also be mounted directly on the excavator arm or only via a rotary unit.

In order to couple the trailer to the excavator, an excavator-side coupling part for a trailer coupling of the trailer can be conveniently arranged on a height-adjustable front shield of the excavator. The trailer can also be mechanically coupled to the excavator using the quick coupler. No separate coupling part is then required on the excavator.

### BRIEF DESCRIPTION OF THE DRAWINGS

Further special features and advantages of the invention will become apparent the following description of a preferred embodiment example with reference to the drawing. In the following figures:

FIG. 1 is a construction equipment arrangement with an excavator and a trailer coupled to the excavator in a schematic side view;

FIG. 2 is an enlarged and partially sectioned view of a connection between a quick coupler arranged on the excavator and an adapter arranged on the trailer;

FIG. 3 is a bottom view of a quick coupler arranged on an excavator arm by means of a rotating and swiveling unit;

FIG. 4 is a trailer with an adapter and,

FIG. 5 is an enlarged view of the adapter of FIG. 4 arranged on the trailer.

### DETAILED DESCRIPTION

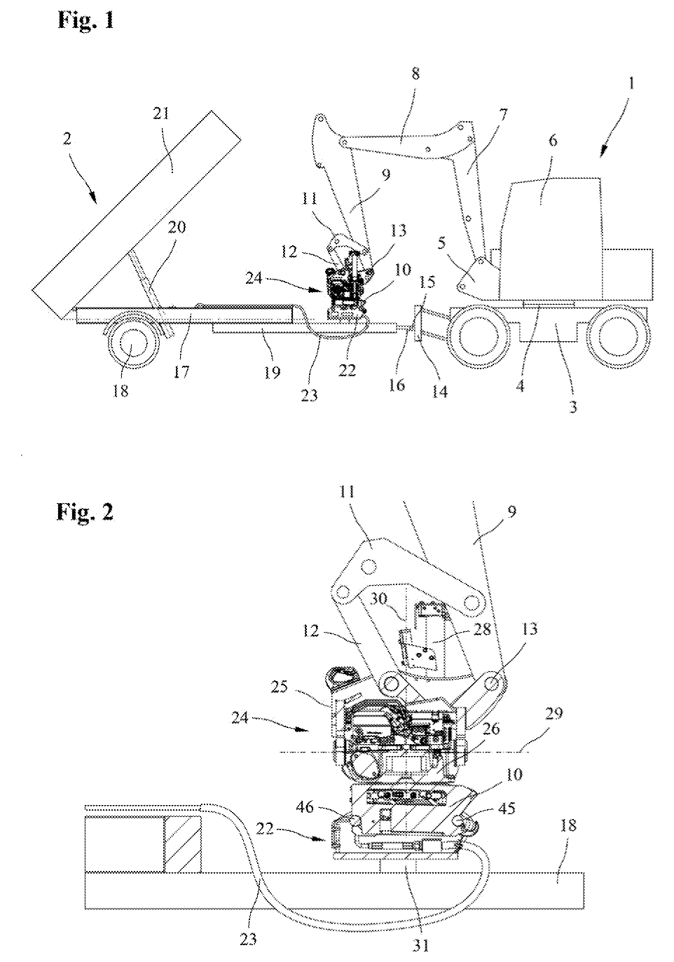

FIG. 1 shows a construction equipment arrangement with an excavator 1 and a trailer 2 coupled to the excavator 1. The excavator 1, which is designed as a wheeled excavator in the version shown, comprises an undercarriage 3 and an upper carriage 5 with a driver's cab 6, which is rotatably mounted on the undercarriage 3 by means of a slewing ring 4. A boom, designed here as an adjustable boom, is arranged on the upper carriage 5 with a first boom section 7 pivotably hinged to the upper carriage 5 and a second boom section 8 pivotably arranged on the first boom section 7. An excavator arm 9 is pivotably deflected on the second boom section 8.

A quick coupler 10 designed for the automatic and rapid changing of attachments is arranged on the excavator arm 10 via a rocker 11 and a coupler 12 so that it can pivot about a horizontal pin 13 at the lower end of the excavator arm 9. A height-adjustable front shield 14 with a coupling part 15 on the excavator side for connection to a trailer coupling 16 on the trailer 2 is also attached to the undercarriage 3 of the excavator 1. The trailer 2, designed here as a reverse tipper, has a chassis 17 with wheels 18, a trailer drawbar 19 with the trailer coupling 16 and a trailer part 21 arranged on the chassis 17 so as to be adjustable by means of an adjusting element 20. In the embodiment shown, the adjustable trailer section 21 is designed as a loading trough that can be tilted backwards. The adjusting element 20 is designed as a hydraulically actuated adjusting cylinder. In FIG. 1, the quick coupler 10 arranged on the excavator arm 9 is coupled to an adapter 22 arranged on the trailer 2. The adapter 22 is connected via a supply line 23 to the adjusting element 20, designed as an actuating cylinder, for raising and lowering the trailer part 21, which is designed as a tiltable loading trough.

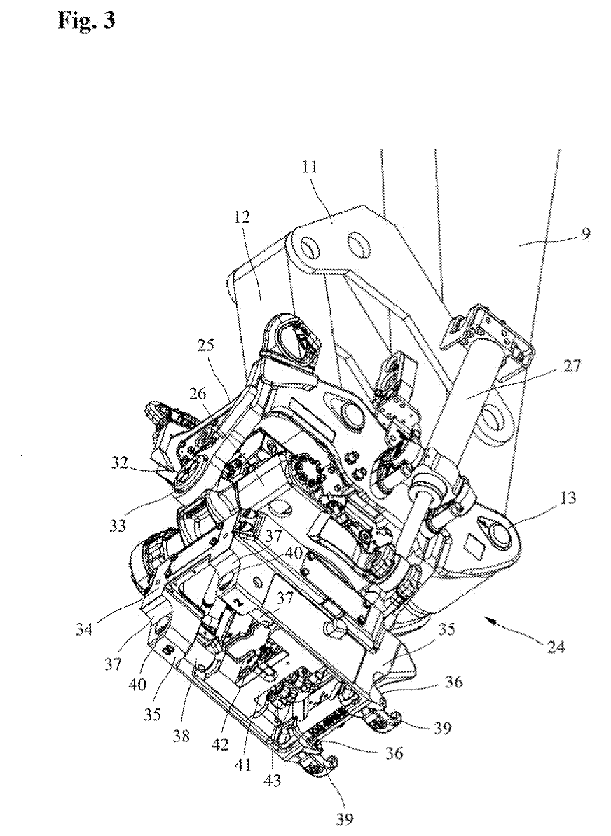

As can be seen in particular from FIG. 2, in the embodiment shown, the quick coupler 10 is arranged on the excavator arm 9 and the coupler 12 via a rotating and swiveling unit 24, also known as a tiltrotator. The rotating and swiveling unit 24 shown in a lower view in FIG. 3 comprises a carrier 25 mounted on the excavator arm 9 and the coupler 12, on which a housing 26 is arranged to swivel about a swivel axis 29 arranged transversely to the longitudinal axis of the excavator arm by means of a swivel drive formed here by two hydraulic actuating cylinders 27 and 28. In the housing 26, which can swivel about the swivel axis 29, the quick changer 10 designed for the automatic changing of attachments is mounted so as to rotate about an axis of rotation 30 orthogonal to the swivel axis 29 and can be rotated 360° relative to the housing 26 about the axis of rotation 30 by a motor via a gear arranged inside the housing 26. In addition, the carrier 25 of the rotating and swiveling unit 24 can be tilted about the pin 13 at the lower end of the excavator arm 9 in a manner known per se by means of the coupling 12 hinged to the excavator arm 9 by means of the rocker 11 and a tilting cylinder not shown.

In the position shown in FIG. 2, the quick coupler 10 arranged on the excavator arm 9 and the coupler 12 via the rotating and swiveling unit 24 is coupled to the adapter 22 arranged on the trailer 2. The adapter 22 can be attached to the trailer 2 either directly or via a damping element 31 shown in FIG. 2.

FIG. 3 shows that the housing 26 is arranged on the carrier 25 via laterally projecting bearing journals 32 within two spaced-apart bearing eyes 33 so that it can swivel about the swivel axis 29, which is orthogonal to the axis of rotation 30, and can be tilted relative to the carrier 25 by approximately +/- 45° about the swivel axis 29 shown in FIG. 2 via the hydraulic swivel drive formed by the two actuating cylinders 27 and 28. As a result, the quick coupler 10 can not only be rotated through 360° about the axis of rotation 30, also shown in FIG. 2, but can also be tilted relative to the carrier 25 about the swivel axis 29 orthogonal to the axis of rotation 30, thus extending the range of movement and thereby increasing the range of application.

FIG. 3 also shows that the quick changer 10, which is rotatably mounted within the housing 26, contains a changer housing 34 designed as a welded or cast part with two side cheeks 35 spaced apart and parallel to each other. On one side of the coupler housing 34 there are first receptacles 36 open towards the front for receiving and holding a first bolt-shaped or axle-shaped coupling element, and on the other side there are second receptacles 37 open towards the bottom with locking elements 38 for receiving and holding a second bolt-shaped or axle-shaped coupling element. Hinged catch hooks 39 are arranged on the first receptacles 36, which are open at the front, to prevent an attachment from falling.

In the embodiment shown, the quick coupler 10 contains two spaced-apart first receptacles 36 for a first bolt-shaped or axle-shaped coupling element on one side of the two side cheeks 35 of the coupler housing 34 and two spaced-apart second receptacles 37 for a second bolt-shaped or axle-shaped coupling element on the other side of the two side cheeks 35. The first receptacles 36, which are open towards the front, are claw-shaped or fork-shaped. The downwardly open second receptacles 37 have a curved lower contact surface for contacting the second bolt-shaped or axle-shaped coupling element. In the embodiment shown, the quick coupler 10 also comprises two locking elements 38 designed as locking bolts, which are guided in guide bores 40 in the two side cheeks 35 of the coupler housing 34, as shown in FIG. 3, and can be moved hydraulically between a retracted release position shown in FIG. 3 for releasing or coupling an attachment and an extended locking position by an actuating element 41, which is H-shaped in the bottom view and is also referred to as an H-cylinder. In the extended locking position, the downwardly open second receptacles 37 are closed on the underside by the locking elements 38 arranged in the guide bores 40, so that the second bolt-shaped coupling element is gripped and held by the locking elements 38.

In order to couple, for example, an excavator bucket or another attachment with the aid of such a quick coupler 10, the quick coupler 10 arranged on the excavator 1 is first moved in such a way that a first pin-shaped or axle-shaped coupling element arranged, for example, on an adapter or directly on the attachment is moved into the claw-shaped or fork-shaped first receptacles 36 on one side of the quick coupler 10. Then, with the locking elements 38 still retracted, the quick coupler 10 is pivoted around the first bolt-shaped or axle-shaped coupling element in such a way that a second bolt-shaped or axle-shaped coupling element on the adapter or attachment comes into contact with the contact surfaces of the downwardly open second receptacles 37 on the other side of the quick coupler 10. Subsequently, the locking elements 38 arranged displaceably in the guide bores 40 in the coupler housing 34 of the quick coupler 10 can be hydraulically extended by corresponding displacement of the actuating element 41, so that the second bolt-shaped or axle-shaped coupling element is gripped underneath by the two locking elements 38 on the quick coupler 10 and the attachment is thus held on the quick coupler 1.

As can be seen from FIG. 3, hydraulic and possibly also electrical first coupling elements 42 are provided on a central part of the actuating element 41 of the quick coupler 10, which is also referred to as the H-cylinder and serves to displace the locking elements 38. These first coupling elements 42, designed for example as hydraulic quick coupling sleeves or as electrical sockets, are connected via suitable connections 43 to corresponding supply lines and are designed in a manner known per se to be coupled to corresponding second coupling elements on a hydraulically or electrically actuated attachment when the actuating element 41 is displaced into the locking position. The second coupling elements can, for example, be designed as quick-coupling plugs for connection to the first coupling elements 42 designed, for example, as quick-coupling sleeves or bushings. This means that the hydraulically or electrically operated attachments can be supplied with hydraulic or electrical power and controlled from the excavator 1.

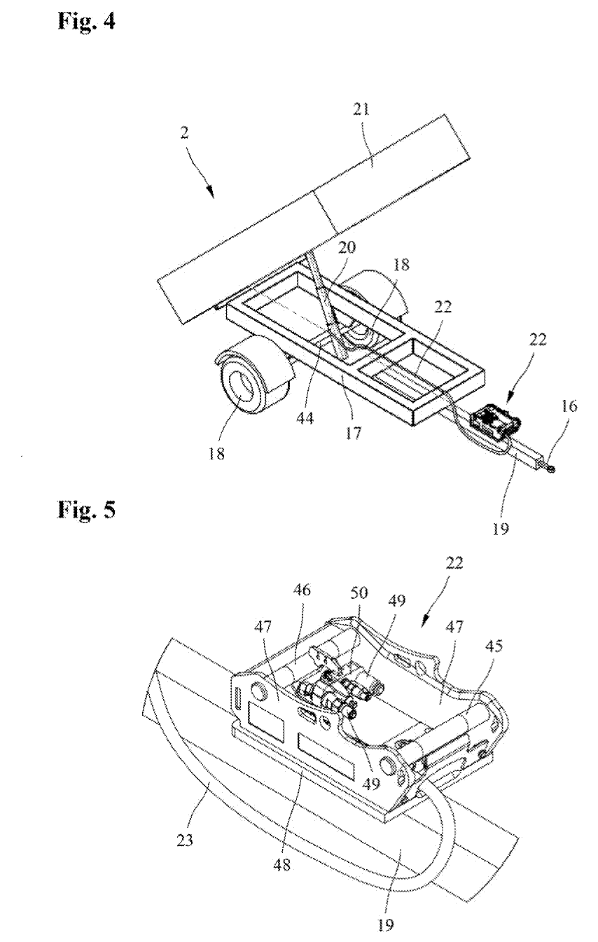

FIG. 4 shows a schematic perspective view of a trailer 2 with an adapter 22 designed for coupling with the quick coupler 10 described above. As already explained, the trailer 2, designed here as a dump truck that can be tipped backwards, has a frame-shaped chassis 17 with a trailer drawbar 19 and the trailer coupling 16 and a trailer part 21, which is designed here as a trough that can be tipped by means of an adjusting element 20, which is designed here as a telescopic cylinder. In the embodiment shown, the trailer 2 has only one axle 44 and two wheels 18. However, the trailer 2 can also have multiple axles or be fitted with a different body. In addition to the adjusting element 20, which is designed here as an actuating cylinder, the trailer 2 can also contain other hydraulically or electrically operated actuating elements.

The adapter 22 arranged here on the trailer drawbar 19 and shown enlarged in FIG. 5 comprises a first bolt-shaped or axle-shaped coupling element 45 designed to engage in the first receptacles 36 of the quick coupler 10 and a second bolt-shaped or axle-shaped coupling element 46 designed to engage in the second receptacles 36 of the quick coupler 10. In the embodiment shown, the two bolt-shaped or axle-shaped coupling elements 45 and 46, which are parallel to and spaced apart from one another, are arranged with their ends in two plate-shaped side parts 47, which are parallel to and spaced apart from one another. The two plate-shaped side parts 47 are arranged projecting upwards on a base plate 48. Second coupling elements 49, designed here as quick coupling plugs, are also attached to the adapter 21 for connection to the first coupling elements 42 arranged on the quick coupler 10. In the embodiment shown in FIG. 5, the second coupling elements 49 designed as quick coupling plugs are arranged in a coupling element carrier 50 attached to the second coupling element. In the embodiment shown, a supply line 23 leading to the adjusting element 20 and designed as a connecting hose is connected to one of the second coupling elements 49 of the adapter 22 attached to the trailer 2. This enables the tiltable body 21 of the trailer 2 to be raised or lowered from the excavator 1 even without a separate control device.

While a mechanical connection between the excavator-side quick coupler 10 and the trailer-side adapter 21 is achieved via the first and second coupling elements 45 and 46, the first coupling element 42 provided on the quick coupler 10 and the second coupling element 49 arranged on the adapter 22 of the trailer 2 and connected to the adjusting element 20 via the supply line 23 enable the adjusting element 20 on the trailer 2 to be controlled. A hydraulic connection between the quick coupler 10 and the trailer 2 is thus established at the same time as the locking mechanism on the quick coupler is actuated. Other hydraulic, pneumatic or electric coupling elements can also be used to control other hydraulically or electrically operated actuating elements on the trailer 2 easily from the excavator 1 via the quick coupler 10, even without complex additional controls.

The trailer 2 described above does not necessarily have to be mechanically coupled to the excavator 1 via the trailer coupling 16 and a corresponding coupling part 15 on the excavator side. The mechanical connection between the excavator 1 and the trailer 2 can also be made via the excavator-side quick coupler 10 and the trailer-side adapter 22.

### LIST OF REFERENCE NUMBERS

1 Excavator

2 Trailer

3 Undercarriage

4 Slewing ring

5 Upper carriage

6 Driver’s cab

7 First boom section

8 Second boom section

9 Excavator arm

10 Quick coupler

11 Rocker

12 Coupler

13 Bolt

14 Front shield

15 Excavator-side coupling part

16 Trailer coupling

17 Chassis

18 Wheel

19 Trailer drawbar

20 Adjusting element

21 Trailer part

22 Adapter

23 Supply line

24 Rotating and swiveling unit

25 Carrier

26 Housing

27 Actuating cylinder

28 Actuating cylinder

29 Swivel axis

30 Axis of rotation

31 Damping element

32 Bearing journal

33 Bearing eyes

34 Changer housing

35 Side panel

36 First receptacles

37 Second receptacles

38 Locking element

39 Catch hook

40 Guide hole

41 Actuating element (H-cylinder)

42 First coupling element

43 Connection

44 Axis

45 First coupling element

46 Second coupling element

47 Side panel

48 Base plate

49 Second coupling element

50 Coupling element carrier

1. A trailer for coupling to an excavator equipped with a hydraulic quick coupler, the trailer comprising a chassis with wheels and at least one trailer part arranged on the chassis so as to be adjustable by means of an adjusting element,
wherein an adapter designed for coupling to the quick coupler is arranged on the trailer with at least one second coupling element designed for engagement with a first coupling element on the quick coupler when the quick coupler is coupled to the adapter, for supplying and actuating the adjusting element from the excavator.

2. The trailer according to claim 1, wherein the adjustable trailer part is a loading trough or loading surface arranged tiltably on the chassis and the adjusting element is an adjusting cylinder arranged between the chassis and the loading trough or loading surface.

3. The trailer according to claim 1, wherein the at least one second coupling element arranged on the adapter is connected to the adjusting element via a supply line.

4. The trailer according to claim 1, wherein the at least one second coupling element arranged on the adapter is designed as a hydraulic, pneumatic, or electric quick coupling plug.

5. The trailer according to claim 1, wherein the at least one second coupling element comprises a plurality of second coupling elements designed to engage with first coupling elements on the quick coupler are arranged on the adapter.

6. The trailer according to claim 1, wherein the adapter comprises a first bolt-shaped or axle-shaped coupling element designed to engage with first receptacles of the quick coupler and a second bolt-shaped or axle-shaped coupling element designed to engage with second receptacles of the quick coupler.

7. The trailer according to claim 6, wherein the at least one second coupling element arranged on the adapter is held on the second coupling element of the adapter via a coupling element carrier.

8. The trailer according to claim 1, wherein the adapter is arranged on a trailer drawbar.

9. The trailer according to claim 8, wherein the adapter is attached to the trailer drawbar directly or via a damping element.

10. A construction equipment arrangement comprising an excavator equipped with a hydraulic quick coupler and the trailer according to claim 1, wherein the trailer is coupled to the excavator.

11. The trailer according to claim 10, wherein the quick coupler is attached to an excavator arm of the excavator via a rotating and swiveling unit.

12. The trailer according to claim 10, wherein a coupling part on the excavator side for a trailer coupling of the trailer is arranged on a height-adjustable front shield of the excavator.
